(19) United States
(12) Patent Application Publication
(10) Pub. No.: US 2022/0415085 A1
(43) Pub. Date: Dec. 29, 2022

(54) METHOD OF MACHINE LEARNING AND FACIAL EXPRESSION RECOGNITION APPARATUS

(71) Applicant: FUJITSU LIMITED, Kawasaki-shi (JP)

(72) Inventors: Ryosuke KAWAMURA, Kawasaki (JP); Kentaro MURASE, Yokohama (JP)

(73) Assignee: FUJITSU LIMITED, Kawasaki-shi (JP)

(21) Appl. No.: 17/718,344

(22) Filed: Apr. 12, 2022

(30) Foreign Application Priority Data
Jun. 29, 2021 (JP) 2021-107569

(51) Int. Cl. G06V 40/16; G06T 7/20; G06T 7/00; G06N 20/20

(52) U.S. Cl. CPC G06V 40/174; G06T 7/20; G06T 7/97; G06N 20/20

(57) ABSTRACT

A non-transitory computer-readable recording medium stores a program that causes a computer to execute a process, the process includes inputting each of first images that includes a face of a subject to a first machine learning model to obtain a recognition result that includes information indicating first occurrence probability of each of facial expressions in each first image, generating training data that includes the recognition result and second images that are respectively generated based on the first images and in which at least a part of the face of the subject is concealed, and performing training of a second machine learning model, based on the training data, by using a loss function that represents an error that relates to a second occurrence probability of each facial expression in each second image and relates to magnitude relationship in the second occurrence probability among the second images.

### CROSS-REFERENCE TO RELATED APPLICATION

This application is based upon and claims the benefit of priority of the prior Japanese Patent Application No. 2021-107569, filed on Jun. 29, 2021, the entire contents of which are incorporated herein by reference.

### FIELD

The embodiment discussed herein is related to a method of machine learning and a facial expression recognition apparatus.

### BACKGROUND

Due to the development of image processing techniques in recent years, there has been developed a system that detects a subtle change in a state of mind of a person from facial expression and performs a process in accordance with the detected change in the state of mind. For example, there is a technique in which a camera is mounted on a robot, and based on an image acquired by the camera, the robot is caused to recognize a change in facial expression of a person with whom the robot deals, to detect a change in emotion of the person, and to perform appropriate response.

As a representative method for describing a change in facial expression, there is a method for describing facial expression using action units (AUs) that are minimum units of movement of facial expression of a face. AUs describe movement of facial expression muscles, and several tens of kinds of AUs such as AU01 and AU12 are defined for each AU corresponding to the facial expression muscles. For example, an eyebrow, a mouth, or the like may be used as the action unit. By using such AUs, it is possible to describe a fine change in facial expression. For this reason, it is possible to recognize a change in facial expression by recognizing a change in AUs.

As a technique that uses such AUs, for example, there is a technique of adaptively generating an attention map corresponding to an occurrence location of an action unit. According to this technique, for each occurrence location of an action unit, a portion to be paid attention to by a model is designated and limited as an AU occurrence region. Then, recognition of each action unit is performed by recognizing a state of each AU occurrence region. For example, in a case of an eyebrow, which is an action unit, recognition of movement of an eyebrow is performed by designating the vicinity of the eyebrow as the AU occurrence region.

As an image recognition technique, a technique has been proposed in which identification of an action unit in a face image, an emotion category, or the like is performed by training of a neural network using first and second face image groups. Another technique has been proposed in which a normal face image, a sunglass face image, and a hat face image are stored in association with each other, and personal identification is performed also in consideration of a feature point of a portion such as a hat or sunglasses in the captured face image.

Japanese National Publication of International Patent Application No. 2019-517693 and Japanese Laid-open Patent Publication No. 2011-076439 are disclosed as related art.

“JAA-Net: Joint Facial Action Unit Detection and Face Alignment via Adaptive Attention” is also disclosed as related art.

### SUMMARY

According to an aspect of the embodiment, a non-transitory computer-readable recording medium stores a program that causes a computer to execute a process, the process includes inputting each of a plurality of first images that includes a face of a subject to a first machine learning model to obtain a facial expression recognition result that includes information indicating first occurrence probability of each of a plurality of facial expressions in each of the plurality of first images, generating training data that includes the facial expression recognition result and a plurality of second images that are respectively generated based on the plurality of first images and in which at least a part of the face of the subject is concealed, and performing training of a second machine learning model, based on the training data, by using a loss function that represents an error that relates to a second occurrence probability of each of the plurality of facial expressions in each of the plurality of second images and relates to magnitude relationship in the second occurrence probability among the plurality of second images.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a facial expression recognition apparatus according to an embodiment;

FIG. 2 is a diagram illustrating training using occurrence probabilities;

FIG. 3 is a diagram illustrating training using an occurrence probability index;

FIG. 4 is a flowchart illustrating a training process of a facial expression recognition model by the facial expression recognition apparatus according to the embodiment;

FIG. 5 is a flowchart illustrating a rank error calculation process by the facial expression recognition apparatus according to the embodiment; and

FIG. 6 is a diagram illustrating an example of a hardware configuration of the facial expression recognition apparatus.

### DESCRIPTION OF EMBODIMENT

In the face recognition, since there is a person who wears eyeglasses or the like when imaged, it is conceivable that there is a case where partial concealment exists in the AU occurrence region. When training and estimation are performed by using data in a case where partial concealment exists in the AU occurrence region, in a technique in which a state of an action unit is recognized by designating the AU occurrence region, information in the AU occurrence region decreases and hence, recognition accuracy may decrease. In addition, information such as information on a concealing object, which may be noise for recognition, is also extracted and hence, there is a concern that the recognition accuracy may further decrease.

Hereinafter, an embodiment of a method of machine learning and a facial expression recognition apparatus disclosed in the present application will be described in detail with reference to the drawings. The following embodiment does not limit the method of machine learning and the facial expression recognition apparatus disclosed in the present application.

### EMBODIMENT

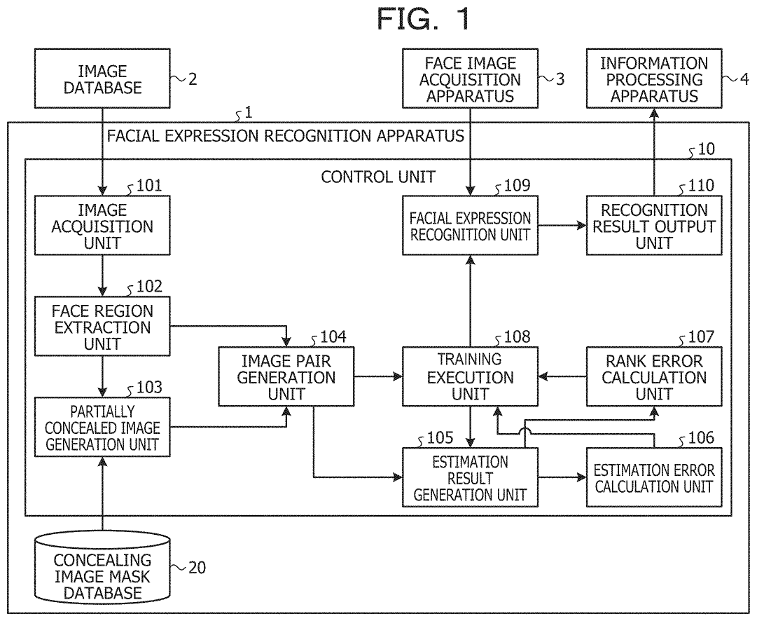

FIG. 1 is a diagram illustrating a facial expression recognition apparatus according to the embodiment. A facial expression recognition apparatus 1 is coupled to an image database 2, a face image acquisition apparatus 3, and an information processing apparatus 4.

The image database 2 stores a plurality of images in which a face is imaged as a bare face without an accessory, such as eyeglasses or a hat, that covers a part of a face. Here, the accessory, such as eyeglasses or a hat, that covers a part of a face is referred to as a concealing object. The image database 2 transmits the stored images to the facial expression recognition apparatus 1.

The face image acquisition apparatus 3 includes an imaging device such as a camera. The face image acquisition apparatus 3 captures a face image of a subject by the imaging device and transmits the face image to the facial expression recognition apparatus 1.

The facial expression recognition apparatus 1 performs, using the plurality of images received from the image database 2, training of a facial expression recognition model that covers a case of a face image with a concealing object. The facial expression recognition apparatus 1 performs a recognition process of a facial expression on the face image received from the face image acquisition apparatus 3 by using the facial expression recognition model after the training is completed. Thereafter, the facial expression recognition apparatus 1 transmits a recognition result of the facial expression to the information processing apparatus 4.

The information processing apparatus 4 receives the recognition result of the facial expression from the facial expression recognition apparatus 1. The information processing apparatus 4 executes a predetermined process by using the acquired recognition result of the facial expression. For example, the information processing apparatus 4 executes a dialogue based on the acquired recognition result of the facial expression.

Next, the facial expression recognition apparatus 1 will be described in detail. The facial expression recognition apparatus 1 includes a control unit 10 and a concealing image mask database 20.

The control unit 10 performs control for training of the facial expression recognition model used for facial expression recognition and control of the facial expression recognition process using the facial expression recognition model. The control unit 10 includes, as illustrated in FIG. 1, an image acquisition unit 101, a face region extraction unit 102, a partially concealed image generation unit 103, an image pair generation unit 104, an estimation result generation unit 105, an estimation error calculation unit 106, a training execution unit 108, and a rank error calculation unit 107. The control unit 10 also includes a facial expression recognition unit 109 and a recognition result output unit 110.

The image acquisition unit 101 acquires a plurality of images in which a bare face without a concealing object is imaged from the image database 2. The image acquisition unit 101 outputs the acquired images to the face region extraction unit 102.

The concealing image mask database 20 is a database that stores a concealing mask image that is an image of a concealing object, such as eyeglasses or a hat, that is superposed on a face image to conceal a part of a face. One or a plurality of types of concealing objects may be provided.

The face region extraction unit 102 receives an input of the plurality of images in which a bare face without a concealing object is imaged from the image acquisition unit 101. The face region extraction unit 102 extracts a face region from each of the acquired images to acquire face region extracted images in which a bare face without a concealing object is imaged. Hereinafter, the face region extracted image in which a bare face without a concealing object is imaged is referred to as a “non-concealed image”. Thereafter, the face region extraction unit 102 outputs the plurality of non-concealed images to the partially concealed image generation unit 103 and the image pair generation unit 104. The plurality of non-concealed images are examples of “plurality of first images”.

The partially concealed image generation unit 103 receives an input of the plurality of non-concealed images from the face region extraction unit 102. The partially concealed image generation unit 103 acquires a concealing mask image from the concealing image mask database 20. Next, the partially concealed image generation unit 103 superposes the concealing mask image on each of the non-concealed images to generate face images in a state where a part of a face is concealed by the concealing object. Hereinafter, the face image in a state where a part of a face is concealed by the concealing object is referred to as a “concealed image”. When there are a plurality of concealing mask images, the partially concealed image generation unit 103 generates, for each concealing mask image, concealed images in which a relevant concealing mask image is superposed on each of the face images. Thereafter, the partially concealed image generation unit 103 outputs the generated plurality of concealed images to the image pair generation unit 104. The plurality of concealed images are examples of “plurality of second images”.

The image pair generation unit 104 receives an input of the plurality of non-concealed images from the face region extraction unit 102. The image pair generation unit 104 receives an input of the plurality of concealed images from the partially concealed image generation unit 103. The image pair generation unit 104 generates image pairs by associating each concealed image with the corresponding non-concealed image that is before concealment. Thereafter, the image pair generation unit 104 outputs each of the images as the image pairs to the estimation result generation unit 105 and the training execution unit 108.

The estimation result generation unit 105 receives an input of each of the images as the image pairs from the image pair generation unit 104. The estimation result generation unit 105 acquires the facial expression recognition model trained by using the non-concealed images from the training execution unit 108. The facial expression recognition model trained by using the non-concealed images is referred to as a “teacher model” hereinafter since the facial expression recognition model is teacher data used when a facial expression recognition model is trained by using the concealed images.

Next, the estimation result generation unit 105 acquires a facial expression recognition model that is trained by using the concealed images. The estimation result generation unit 105 may acquire a facial expression recognition model similar to the teacher model as an initial state of the facial expression recognition model that is trained by using the concealed images, or may acquire an appropriate facial expression recognition model generated in advance as the initial state. Hereinafter, the facial expression recognition model that is trained by using the concealed images is referred to as a “student model”.

Next, the estimation result generation unit 105 acquires concealed images from the image pairs. Next, the estimation result generation unit 105 acquires N images from the concealed images. The estimation result generation unit 105 inputs N concealed images to the student model, and acquires an estimation result of occurrence probabilities of each action unit, based on an estimation result of facial expression recognition of each of the concealed images as an output from the student model.

Next, the estimation result generation unit 105 acquires N non-concealed images that are each an image paired with the corresponding concealed image of the N concealed images. The estimation result generation unit 105 inputs the acquired N non-concealed images to the teacher model, and acquires an estimation result of occurrence probabilities of each action unit, based on an estimation result of facial expression recognition of each of the non-concealed images as an output from the teacher model.

In the estimation results of the facial expression recognition, for each action unit, for example, the amount of movement of each action unit is represented in six stages. For example, when the action unit is a mouth, the amount of movement is represented in six stages such that a state where the mouth is not moved is represented as 1, and a state where the amount of movement of the mouth is the maximum is represented as 6. By using the estimation results of the facial expression recognition, the occurrence probabilities of each action unit in the non-concealed images and the occurrence probabilities of each action unit in the concealed images are estimated.

For example, it is assumed that the action unit has occurred when the estimation result of the facial expression recognition is 2 or more. By using, for each action unit, the data where the occurrence probability in the non-concealed image whose estimation result is 2 or more is set to 1 as the teacher data, the occurrence probability of each action unit whose estimation result is 2 or more is estimated.

Next, the estimation result generation unit 105 outputs information on estimated values of the occurrence probabilities of each action unit in the concealed images and information on estimated values of the occurrence probabilities of each action unit in the non-concealed images to the estimation error calculation unit 106 and the rank error calculation unit 107.

The estimation error calculation unit 106 receives an input of information on the estimated values of the occurrence probabilities of each action unit in the concealed images and information on the estimated values of the occurrence probabilities of each action unit in the corresponding non-concealed images from the estimation result generation unit 105. Next, the estimation error calculation unit 106 sets the occurrence probabilities of each action unit in the non-concealed images as a correct label of the occurrence probabilities of each action unit in the concealed images. For example, in this case, the occurrence probabilities of each action unit are first privilege information. Privilege information is auxiliary information obtained in association with each piece of training data, and is characterized in that the privilege information may be used when training is performed. Hereinafter, the estimated value of the occurrence probability of each action unit in the concealed image is referred to as an “estimated value of the occurrence probability in the concealed image”, and the estimated value of the occurrence probability of each action unit in the non-concealed image is referred to as an “estimated value of the occurrence probability in the non-concealed image”. The estimated value of the occurrence probability in the non-concealed image is an example of a “first occurrence probability”, and the estimated value of the occurrence probability in the concealed image is an example of a “second occurrence probability”.

The estimation error calculation unit 106 calculates, for each action unit, an occurrence probability error that is an error between the estimated value of the occurrence probability in the non-concealed image and the estimated value of the occurrence probability in the concealed image. For example, the estimation error calculation unit 106 calculates, for each action unit, a difference between the estimated value of the occurrence probability in the non-concealed image and the estimated value of the occurrence probability in the concealed image as the occurrence probability error. A function for obtaining the occurrence probability error is an example of “a function that includes, as a parameter, a difference between the first occurrence probability and the second occurrence probability”. The estimation error calculation unit 106 outputs the calculated occurrence probability error of each action unit to the training execution unit 108.

The rank error calculation unit 107 acquires, for each of the image pairs of N concealed images and N non-concealed images, the estimated value of the occurrence probability in the concealed image and the estimated value of the occurrence probability in the non-concealed image from the estimation result generation unit 105. Next, the rank error calculation unit 107 generates, with respect to the occurrence probabilities of the action unit of each pair, for each action unit, an index by ranking by arranging, in descending order of probability, the occurrence probabilities of each action unit in the concealed images. The rank error calculation unit 107 generates, with respect to the occurrence probabilities of the action unit of each pair, for each action unit, an index by ranking by arranging, in descending order of probability, the occurrence probabilities of each action unit in the non-concealed images. Hereinafter, the index in which the occurrence probabilities of the action unit are ranked is referred to as an “occurrence probability index”. Information indicated by the occurrence probability index is an example of “a magnitude relationship in the second occurrence probability among the plurality of second images”.

The rank error calculation unit 107 sets the occurrence probability index for the non-concealed images as a correct label of the occurrence probability index for the concealed images. For example, the index in which the occurrence probabilities of each action unit are ranked is second privilege information. Hereinafter, the index of the occurrence probability of each action unit in the concealed images is referred to as an “estimated value of the occurrence probability index for the concealed images”. The index of the occurrence probability of each action unit in the non-concealed images is referred to as an “estimated value of the occurrence probability index for the non-concealed images”.

The rank error calculation unit 107 calculates a rank error that is an error between the estimated value of the occurrence probability index for the concealed images and the estimated value of the occurrence probability index for the non-concealed images. An example of a calculation method of the rank error will be described in detail. A function for calculating the rank error is an example of “a function that includes, as a parameter, a difference between a magnitude relationship in the first occurrence probability among the plurality of first images and the magnitude relationship in the second occurrence probability among the plurality of second images”.

For example, an AU01, which is an action unit, will be described. The rank error calculation unit 107 sets the occurrence probability of the AU01 in the non-concealed image in each image as yt. It is assumed that the occurrence probabilities of the AU01 in the non-concealed images are 0.7 in the first image, 0.5 in the second image, 0.3 in the third image, and 0.1 in the fourth image. In this case, values of yt are indicated as 1>2>3>4 when the magnitude relationship is represented with the number of each image, and 1>2>3>4 is the estimated value of the occurrence probability index for the non-concealed images.

The rank error calculation unit 107 sets the occurrence probability of the AU01 in the concealed image in each image as ys. It is assumed that the occurrence probabilities of the AU01 in the concealed images are 0.2 in the first image, 0.8 in the second image, 0.4 in the third image, and 0.6 in the fourth image. In this case, values of ys are indicated as 2>4>3>1 when the magnitude relationship is represented with the number of each image, and 2>4>3>1 is the estimated value of the occurrence probability index for the concealed images.

The rank error calculation unit 107 calculates the rank error by using a loss function such as max(0, −t×(ysi−ysj)+m), for example. In the loss function, t is 1 when the order of the index i of yt is larger than j, and is −1 if not. The value m is an arbitrary constant. The value ysi is the occurrence probability in the i-th concealed image, which is estimated by the student model.

For example, consider a case of calculating the rank error between the first image and the second image in a case where the above-described occurrence probability indexes have been generated. In this case, i=1, and j=2. Thus, ysi=0.2, and ysj=0.8. With respect to values of yt, the first image>the second image and hence, t=1. Assuming m=0, the rank error calculation unit 107 calculates the rank error as max(0, −1×(0.2−0.8))=0.6. The rank error calculation unit 107 calculates the rank error for all combinations of i and j. The rank error calculation unit 107 sums the rank errors of all combinations of i and j and sets the sum as the rank error of the AU01. The rank error calculation unit 107 calculates the rank error for all action units in the same manner.

Thereafter, the rank error calculation unit 107 outputs the calculated rank error of each action unit to the training execution unit 108.

The training execution unit 108 includes the teacher model that is a facial expression recognition model to be trained by using the non-concealed images. The training execution unit 108 receives an input of the plurality of non-concealed images and concealed images as the image pairs from the image pair generation unit 104. The training execution unit 108 performs training of the teacher model by using the non-concealed images.

The training execution unit 108 includes the student model that is a facial expression recognition model to be trained by using the concealed images. The training execution unit 108 may use the trained teacher model as the student model.

The training execution unit 108 receives an input of the occurrence probability error of each action unit from the estimation error calculation unit 106. The training execution unit 108 receives an input of the rank error of each action unit from the rank error calculation unit 107. The training execution unit 108 calculates, for each action unit, the sum of the occurrence probability error and the rank error, adjusts the parameters of the student model so as to reduce the calculated value, and updates the student model.

After the training execution unit 108 completes the update of the student model a predetermined number of times, the training execution unit 108 completes training of the student model. The training execution unit 108 outputs the generated student model to the facial expression recognition unit 109 as a trained facial expression recognition model.

The facial expression recognition unit 109 receives an input of the trained facial expression recognition model from the training execution unit 108. Thereafter, the facial expression recognition unit 109 receives a face image acquired by the face image acquisition apparatus 3 from the face image acquisition apparatus 3. The face image may be an image without a concealing object or an image with a concealing object. The facial expression recognition unit 109 inputs the acquired face image to the facial expression recognition model, and acquires an output from the facial expression recognition model. The result of the facial expression recognition as the output from the facial expression recognition model is information indicating the amount of movement of each action unit. The facial expression recognition unit 109 outputs the result of the facial expression recognition to the recognition result output unit 110.

The recognition result output unit 110 receives an input of the result of the facial expression recognition from the facial expression recognition unit 109. The recognition result output unit 110 outputs the acquired result of the facial expression recognition to the information processing apparatus 4.

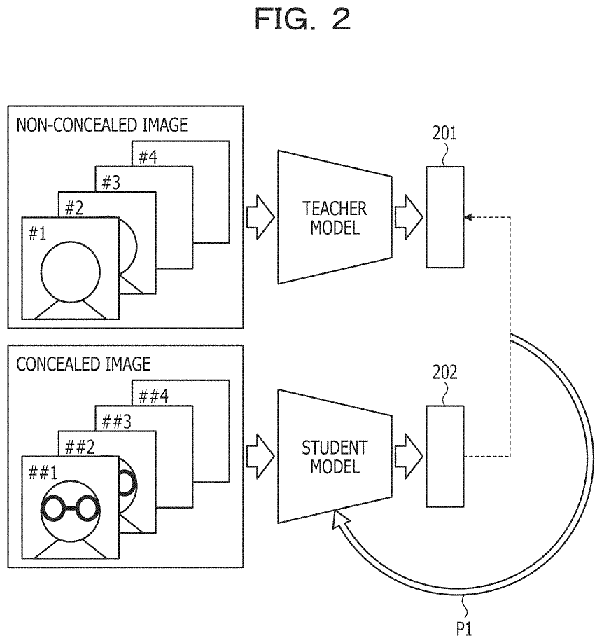

FIG. 2 is a diagram illustrating training using occurrence probabilities. With reference to FIG. 2, the training using the occurrence probabilities will be described.

The estimation result generation unit 105 inputs non-concealed images to the teacher model, and acquires an estimation result 201 formed of the estimated values of the occurrence probabilities in the non-concealed images as an output from the teacher model. The estimation result generation unit 105 inputs concealed images to the student model, and acquires an estimation result 202 formed of the estimated values of the occurrence probabilities in the concealed images as an output from the student model. The estimation error calculation unit 106 obtains an occurrence probability error that is an error between the estimation result 201 and the estimation result 202.

The training execution unit 108 executes training P1 so as to reduce the obtained occurrence probability error, and updates the student model. For example, the training execution unit 108 performs training of the student model by using the estimation result in the non-concealed images as the teacher data. As a result, it is possible to bring the estimation result 202 close to the estimation result 201. As described above, by performing training by using, as the first privilege information, the estimated values of the occurrence probabilities of each action unit, the training execution unit 108 may perform training of the student model by using occurrence information on action units of other parts.

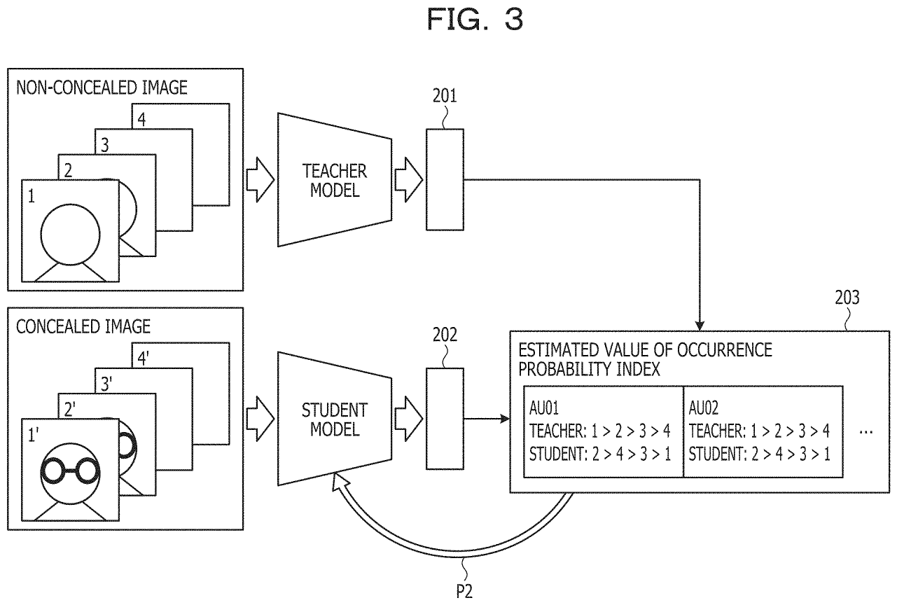

FIG. 3 is a diagram illustrating training using the occurrence probability index. With reference to FIG. 3, the training using the occurrence probability index will be described.

The estimation result generation unit 105 inputs non-concealed images to the teacher model, and acquires the estimation result 201 formed of the estimated values of the occurrence probabilities in the non-concealed images as an output from the teacher model. The estimation result generation unit 105 inputs concealed images to the student model, and acquires the estimation result 202 formed of the estimated values of the occurrence probabilities in the concealed images as an output from the student model.

The rank error calculation unit 107 generates, for each action unit, the estimated value of the occurrence probability index for the non-concealed images by rearranging, in descending order, the estimated values of the occurrence probabilities in the non-concealed images included in the estimation result 201. The rank error calculation unit 107 generates, for each action unit, the estimated value of the occurrence probability index for the concealed images by rearranging, in descending order, estimated values of the occurrence probabilities in the concealed images included in the estimation result 202. As a result, the rank error calculation unit 107 generates an estimated value 203 of the occurrence probability index. Next, the rank error calculation unit 107 sets the estimated values of the occurrence probability index for the non-concealed images included in the estimated value 203 of the occurrence probability index as the teacher data, and sets the estimated values of the occurrence probability index for the concealed images as student data. The rank error calculation unit 107 obtains a rank error that is an error between the teacher data and the student data for each action unit.

The training execution unit 108 executes training P2 so as to reduce the rank error as well as the estimation error, and updates the student model. For example, the training execution unit 108 performs training of the student model by using the estimation result in the non-concealed images as the teacher data. As a result, it is possible to bring the estimation result 202 close to the estimation result 201. As described above, by performing training by using, as the second privilege information, the estimated value of the index in which the occurrence probabilities of each action unit are ranked based on the magnitude of the values, the training execution unit 108 may further improve the estimation accuracy of the student model by performing training using occurrence information on action units of other parts.

As described above, the control unit 10 inputs each of a plurality of first images that includes a face of a subject to a first machine learning model to obtain the occurrence probability of each of a plurality of facial expressions. The control unit 10 generates, based on the plurality of first images, a plurality of second images in which at least a part of the face of the subject is concealed. The control unit 10 trains a second machine learning model based on training data by using a loss function. The training data includes a correct label indicating the occurrence probability of each of the plurality of facial expressions and the plurality of second images. The loss function represents an error relating to the occurrence probability of each of the plurality of facial expressions and relating to the magnitude relationship in the occurrence probability of each of the plurality of facial expressions among the plurality of second images. The control unit 10 receives a first image that includes a face of a first subject. The control unit 10 inputs the first image to the trained second machine learning model, and outputs an estimation result of facial expression recognition relating to the face of the first subject in accordance with an output from the second machine learning model.

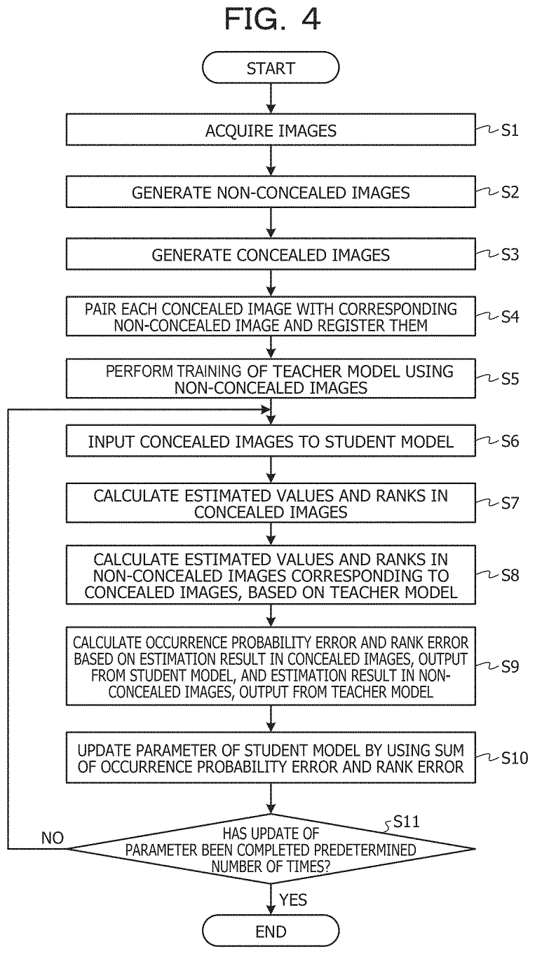

FIG. 4 is a flowchart illustrating a training process of the facial expression recognition model by the facial expression recognition apparatus according to the embodiment. Next, with reference to FIG. 4, a flow of the training process of the facial expression recognition model by the facial expression recognition apparatus 1 according to the embodiment will be described.

The image acquisition unit 101 acquires a plurality of images in which a bare face without a concealing object is imaged from the image database 2 (step S1). The image acquisition unit 101 outputs the acquired images to the face region extraction unit 102.

The face region extraction unit 102 receives an input of the plurality of images from the image acquisition unit 101. The face region extraction unit 102 extracts a face region from each of the acquired images to generate non-concealed images that are face region extracted images in which a bare face without a concealing object is imaged (step S2). Thereafter, the face region extraction unit 102 outputs the generated non-concealed images to the partially concealed image generation unit 103 and the image pair generation unit 104.

The partially concealed image generation unit 103 receives an input of the non-concealed images from the face region extraction unit 102. The partially concealed image generation unit 103 acquires a concealing mask image from the concealing image mask database 20. Next, the partially concealed image generation unit 103 superposes the concealing mask image on each of the non-concealed images to generate concealed images (step S3). Thereafter, the partially concealed image generation unit 103 outputs the generated concealed images to the image pair generation unit 104.

The image pair generation unit 104 receives an input of the non-concealed images from the face region extraction unit 102. The image pair generation unit 104 receives an input of the concealed images from the partially concealed image generation unit 103. The image pair generation unit 104 pairs each concealed image with the corresponding non-concealed image and registers them as an image pair (step S4). Thereafter, the image pair generation unit 104 outputs each of the images as image pairs to the estimation result generation unit 105 and the training execution unit 108.

The training execution unit 108 receives an input of the plurality of non-concealed images and concealed images as the image pairs from the image pair generation unit 104. The training execution unit 108 performs training of the teacher model by using the non-concealed images (step S5).

The estimation result generation unit 105 inputs each of the N concealed images to the student model (step S6).

Next, the estimation result generation unit 105 acquires an output from the student model and calculates estimated values of the occurrence probabilities of each action unit in the respective concealed images, that is, estimated values of the occurrence probabilities in the concealed images. The rank error calculation unit 107 calculates ranks of the occurrence probabilities by rearranging, in descending order, the estimated values of the occurrence probabilities in the concealed images calculated by the estimation result generation unit 105, and generates the estimated value of the occurrence probability index for the concealed images (step S7).

Next, the estimation result generation unit 105 inputs the non-concealed images, which are each an image paired with the corresponding concealed image, to the teacher model, acquires an output from the teacher model, and calculates estimated values of the occurrence probabilities of each action unit in the respective non-concealed images, that is, estimated values of the occurrence probabilities in the non-concealed images. The rank error calculation unit 107 calculates ranks of the occurrence probabilities by rearranging, in descending order, the estimated values of the occurrence probabilities in the non-concealed images calculated by the estimation result generation unit 105, and generates the estimated value of the occurrence probability index for the non-concealed images (step S8). The estimation result generation unit 105 outputs the estimated values of the occurrence probabilities in the concealed images and the estimated values of the occurrence probabilities in the non-concealed images to the estimation error calculation unit 106.

The estimation error calculation unit 106 receives an input of the estimated values of the occurrence probabilities in the concealed images and the estimated values of the occurrence probabilities in the non-concealed images from the estimation result generation unit 105. Next, the estimation error calculation unit 106 calculates an occurrence probability error that is an error between the estimated value of the occurrence probability in the non-concealed image and the estimated value of the occurrence probability in the concealed image. The rank error calculation unit 107 calculates a rank error that is an error between the estimated value of the occurrence probability index for the non-concealed images and the estimated value of the occurrence probability index for the concealed images (step S9). The estimation error calculation unit 106 outputs the occurrence probability error to the training execution unit 108. The rank error calculation unit 107 outputs the rank error to the training execution unit 108.

The training execution unit 108 receives an input of the occurrence probability error from the estimation error calculation unit 106. The training execution unit 108 receives an input of the rank error from the rank error calculation unit 107. The training execution unit 108 obtains the sum of the occurrence probability error and the rank error, and updates the parameters of the student model by using the result obtained (step S10).

Thereafter, the training execution unit 108 determines whether the update of the parameters of the student model has been completed a predetermined number of times (step S11). When the update of the parameters of the student model has not reached the predetermined number of times (step S11: No), the training process of the facial expression recognition model returns to step S6. On the other hand, when the update of the parameters of the student model has been completed the predetermined number of times (step S11: Yes), the training execution unit 108 ends the training process of the facial expression recognition model.

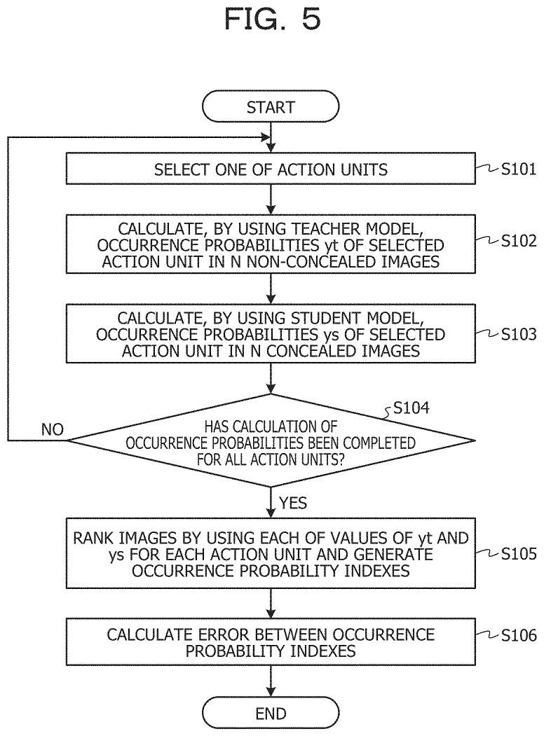

FIG. 5 is a flowchart illustrating a rank error calculation process by the facial expression recognition apparatus according to the embodiment. Next, with reference to FIG. 5, a flow of the rank error calculation process by the facial expression recognition apparatus 1 according to the embodiment will be described in detail.

The estimation result generation unit 105 selects one of action units (step S101).

Next, the estimation result generation unit 105 calculates, by using the teacher model, values of yt that are occurrence probabilities of the selected action unit in the N non-concealed images (step S102).

Next, the estimation result generation unit 105 calculates, by using the student model, values of ys that are occurrence probabilities of the selected action unit in the N concealed images (step S103).

The estimation result generation unit 105 determines whether the calculation of the occurrence probabilities has been completed for all action units (step S104). When the action unit for which the calculation of the occurrence probabilities has not been performed exists (step S104: No), the estimation result generation unit 105 returns to step S101.

On the other hand, when the calculation of the occurrence probabilities has been completed for all action units (step S104: Yes), the estimation result generation unit 105 outputs, for each action unit, values of yt that are occurrence probabilities in the concealed images and values of ys that are occurrence probabilities in the non-concealed images to the rank error calculation unit 107. The rank error calculation unit 107 ranks, for each action unit, the concealed images and the non-concealed images based on the magnitude of the estimated occurrence probabilities by using each of the values of yt and ys, and generates the occurrence probability indexes (step S105).

Thereafter, the estimation result generation unit 105 calculates the rank error that is an error between the occurrence probability index for the non-concealed images and the occurrence probability index for the concealed images (step S106).

As described above, the facial expression recognition apparatus according to the embodiment uses the occurrence probabilities of each action unit in the non-concealed images and the concealed images as the first privilege information. In the facial expression recognition apparatus according to the embodiment, in addition to the errors between the occurrence probabilities of each action unit in the respective images, the ranks of the respective images ranked based on the magnitude of the occurrence probabilities are used as the second privilege information to perform training of the facial expression recognition model using the concealed images.

It is considered that, for recognition of an action unit, information other than information related to the relevant action unit may be used. For example, in a case where recognition for a specific action unit is performed, it is conceivable to use the presence or absence of occurrence of other action units that occur in synchronization with occurrence of the specific action unit. However, in related art in which a state of the action unit is recognized by designating an AU occurrence region, it is difficult to extract information on a portion other than a portion designated as the AU occurrence region, and it is difficult to use the presence or absence of occurrence of other action units. For this reason, in a case where a part of the AU occurrence region is concealed, in the related art in which the state of the action unit is recognized by designating an AU occurrence region, it is difficult to improve the recognition accuracy of the state of the action unit.

In the technology of performing identification or the like of an action unit and an emotion category in first and second face image groups by training of a neural network, concealment of a part of an AU occurrence region is not taken into consideration and hence, it is difficult to improve the recognition accuracy of the state of the action unit. The technique in which a normal face image, a sunglass face image, and a hat face image are stored in association with each other, and personal identification is performed is merely an image recognition and hence, it is difficult to use such a technique to recognize a state of an action unit.

On the other hand, the facial expression recognition apparatus according to the embodiment is capable of using occurrence states of other action units when performing estimation of movement of a specific action unit. For this reason, even in a case where a region of an action unit of an estimation target is partially concealed, it is possible to improve the estimation accuracy. Since the information on the concealing object is not learned, even when a region of an action unit is partially concealed by a concealing object, it is possible to improve the estimation accuracy. Even in the concealed images and the non-concealed images, it is considered that the order of the magnitude of the occurrence probabilities of the AU is the same among the images. Accordingly, by using the ranks of the images, it is possible to perform training in which the occurrence probability of the AU is more appropriately taken into consideration, and it is possible to improve the accuracy of the facial expression recognition by the facial expression recognition model.

(Hardware Configuration)

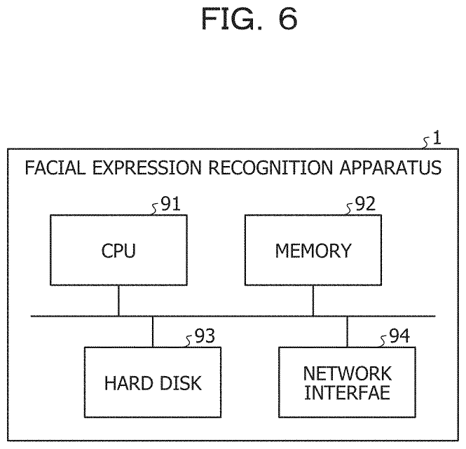

FIG. 6 is a diagram illustrating an example of a hardware configuration of the facial expression recognition apparatus. The facial expression recognition apparatus 1 according to the embodiment includes, for example, a hardware configuration illustrated in FIG. 8. For example, the facial expression recognition apparatus 1 includes a central processing unit (CPU) 91, a memory 92, a hard disk 93, and a network interface 94. The CPU 91 is coupled to the memory 92, the hard disk 93, and the network interface 94 via a bus.

The network interface 94 is an interface for communication between the facial expression recognition apparatus 1 and an external apparatus. The network interface 94 relays communication between the CPU 91 and the image database 2, the face image acquisition apparatus 3, or the information processing apparatus 4, for example.

The hard disk 93 is an auxiliary storage device. The hard disk 93 implements the function of the concealing image mask database 20, for example. The hard disk 93 stores various programs including a program for implementing the function of the control unit 10 exemplified in FIG. 1.

The memory 92 is a primary storage device. For example, dynamic random-access memory (DRAM) may be used as the memory 92.

The CPU 91 reads various programs from the hard disk 93, loads the programs into the memory 92, and executes the programs. Accordingly, the CPU 91 may implement the function of the control unit 10 exemplified in FIG. 1.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program that causes a computer to execute a process, the process comprising:
inputting each of a plurality of first images that includes a face of a subject to a first machine learning model to obtain a facial expression recognition result that includes information indicating first occurrence probability of each of a plurality of facial expressions in each of the plurality of first images;
generating training data that includes the facial expression recognition result and a plurality of second images that are respectively generated based on the plurality of first images and in which at least a part of the face of the subject is concealed; and
performing training of a second machine learning model, based on the training data, by using a loss function that represents an error that relates to a second occurrence probability of each of the plurality of facial expressions in each of the plurality of second images and relates to a magnitude relationship in the second occurrence probability among the plurality of second images.

2. The non-transitory computer-readable recording medium according to claim 1, the process further comprising:
determining whether a predetermined facial expression occurs based on information that indicates movement of a facial expression muscle in a predetermined region of the face of the subject.

3. The non-transitory computer-readable recording medium according to claim 1, the process further comprising:
generating the plurality of second images by superposing an image on each of the plurality of first images to conceal a part of each of the plurality of first images.

4. The non-transitory computer-readable recording medium according to claim 1, wherein
the loss function is a function that includes, as parameters,
a difference between the first occurrence probability and the second occurrence probability, and
a difference between a magnitude relationship in the first occurrence probability among the plurality of first images and the magnitude relationship in the second occurrence probability among the plurality of second images.

5. A method of machine learning, the method comprising:
inputting, by a computer, each of a plurality of first images that includes a face of a subject to a first machine learning model to obtain a facial expression recognition result that includes information indicating first occurrence probability of each of a plurality of facial expressions in each of the plurality of first images;
generating training data that includes the facial expression recognition result and a plurality of second images that are respectively generated based on the plurality of first images and in which at least a part of the face of the subject is concealed; and
performing training of a second machine learning model, based on the training data, by using a loss function that represents an error that relates to a second occurrence probability of each of the plurality of facial expressions in each of the plurality of second images and relates to a magnitude relationship in the second occurrence probability among the plurality of second images.

6. A facial expression recognition apparatus, comprising:
a memory; and
a processor coupled to the memory and the processor configured to:
input each of a plurality of first images that includes a face of a subject to a first machine learning model to obtain a facial expression recognition result that includes information indicating first occurrence probability of each of a plurality of facial expressions in each of the plurality of first images;
generate training data that includes the facial expression recognition result and a plurality of second images that are respectively generated based on the plurality of first images and in which at least a part of the face of the subject is concealed; and
perform training of a second machine learning model, based on the training data, by using a loss function that represents an error that relates to a second occurrence probability of each of the plurality of facial expressions in each of the plurality of second images and relates to a magnitude relationship in the second occurrence probability among the plurality of second images.
